(19) United States
(12) Patent Application Publication
(10) Pub. No.: US 2025/0233332 A1
(43) Pub. Date: Jul. 17, 2025

(54) PROTECTOR AND BUSBAR MODULE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP)

(21) Appl. No.: 19/004,140

(22) Filed: Dec. 27, 2024

(30) Foreign Application Priority Data
Jan. 15, 2024 (JP) 2024-003689

(51) Int. Cl. H01R 12/77; H01M 50/507; H01R 12/91; H01R 13/506

(52) U.S. Cl. CPC H01R 12/772; H01M 50/507; H01R 12/91; H01R 13/506

(57) ABSTRACT

A protector includes a case unit including an accommodation chamber that accommodates an extra length portion of a flexible printed wiring board to which a connector is connected, and a guide portion extending along a sliding direction; and a slide body that includes a holding portion that holds a portion between the connector and the extra length portion in the flexible printed wiring board and moves along the sliding direction while being guided by the guide portion. The case unit and the slide body are configured to cause the extra length portion to be extended from the accommodation chamber when the slide body is moved to a first side in the sliding direction, and cause the extra length portion extending from the accommodation chamber to be accommodated in the accommodation chamber when the slide body is moved to a second side in the sliding direction.

### CROSS-REFERENCE TO RELATED APPLICATION(S)

The present application claims priority to and incorporates by reference the entire contents of Japanese Patent Application No. 2024-003689 filed in Japan on Jan. 15, 2024.

### BACKGROUND OF THE INVENTION

### 1. Field of the Invention

The present invention relates to a protector and a busbar module.

### 2. Description of the Related Art

Conventionally, there is a technique of connecting a connector connected to a flexible board to a mating connector. Japanese Patent Application Laid-open No. 2020-021595 A discloses a circuit body with a connector including a circuit body configured by a flexible board provided with a wiring pattern and a connector attached to the circuit body.

It is desirable that the workability of the work of connecting the connector connected to the flexible printed wiring board to the mating connector can be improved. For example, in a configuration in which the flexible printed wiring board is protected by the protector, it is desirable that the connector is positioned at an appropriate position with respect to the mating connector even if both the protector and the mating connector are fixed.

### SUMMARY OF THE INVENTION

An object of the present invention is to provide a protector and a busbar module capable of improving workability of work of connecting a connector connected to a flexible printed wiring board to a mating connector.

In order to achieve the above mentioned object, a protector according to one aspect of the present invention includes a case unit including an accommodation chamber that accommodates an extra length portion of a flexible printed wiring board to which a connector is connected, and a guide portion extending along a sliding direction; and a slide body that includes a holding portion that holds a portion between the connector and the extra length portion in the flexible printed wiring board, and moves along the sliding direction while being guided by the guide portion, wherein the case unit and the slide body are configured to cause the extra length portion to be extended from the accommodation chamber when the slide body is moved to a first side in the sliding direction, and cause the extra length portion extending from the accommodation chamber to be accommodated in the accommodation chamber when the slide body is moved to a second side in the sliding direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a busbar module according to an embodiment;

FIG. 2 is a perspective view of a protector according to the embodiment;

FIG. 3 is a plan view of the protector according to the embodiment;

FIG. 4 is a plan view of the protector according to the embodiment;

FIG. 5 is a perspective view of a case unit and a flexible printed wiring board according to the embodiment;

FIG. 6 is a cross-sectional perspective view of the case unit and the flexible printed wiring board according to the embodiment;

FIG. 7 is a perspective view of the protector according to the embodiment;

FIG. 8 is a cross-sectional perspective view of the protector according to the embodiment;

FIG. 9 is a cross-sectional view of the protector according to the embodiment.;

FIG. 10 is a cross-sectional view of the protector according to the embodiment;

FIG. 11 is a plan view of a protector according to a modified example of the embodiment; and

FIG. 12 is a plan view of a protector according to a modified example of the embodiment.

### DETAILED DESCRIPTION OF THE PREFERRED EMBODIMENTS

Hereinafter, a protector and a busbar module according to an embodiment of the present invention will be described in detail with reference to the drawings. Note that the present invention is not limited by the embodiment. In addition, constituent elements in the following embodiment include those that can be easily assumed by those skilled in the art or those that are substantially the same.

### Embodiment

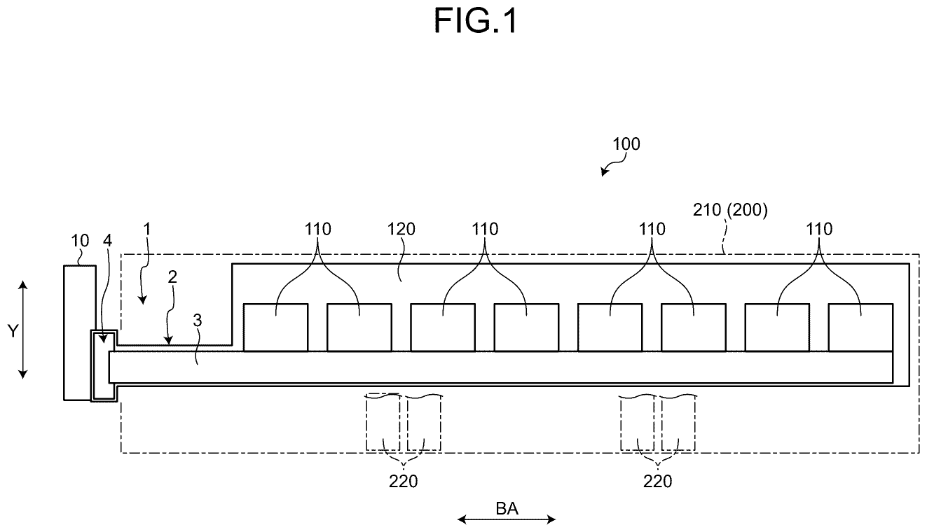

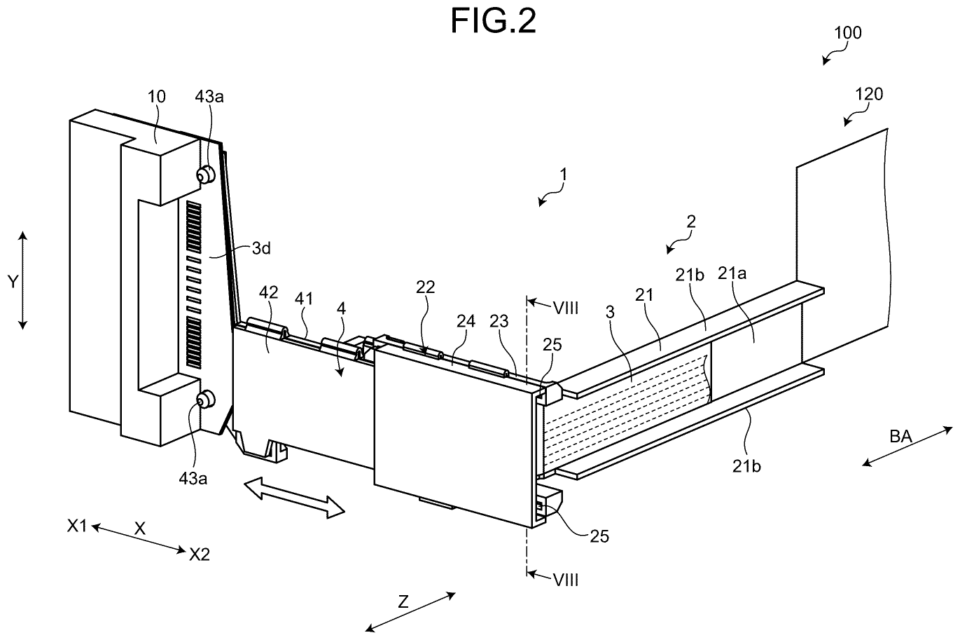

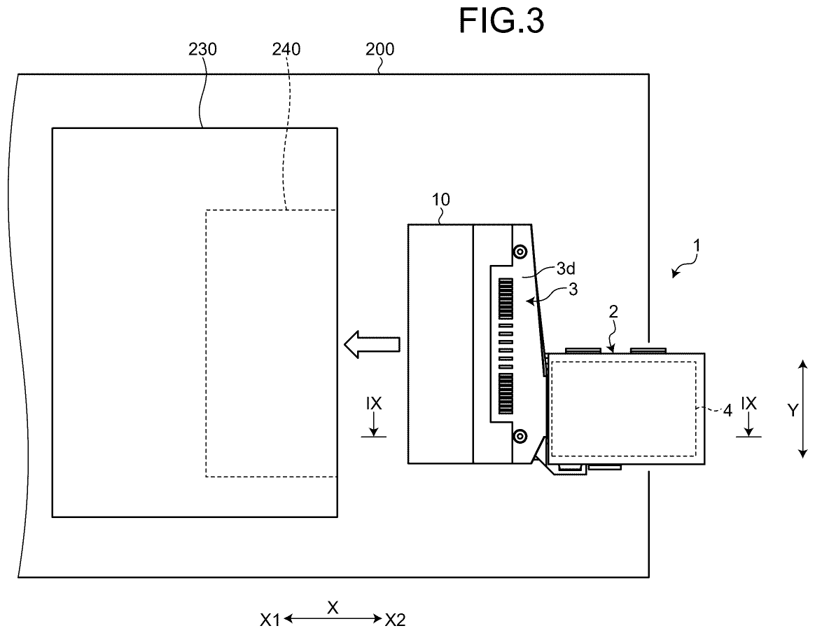

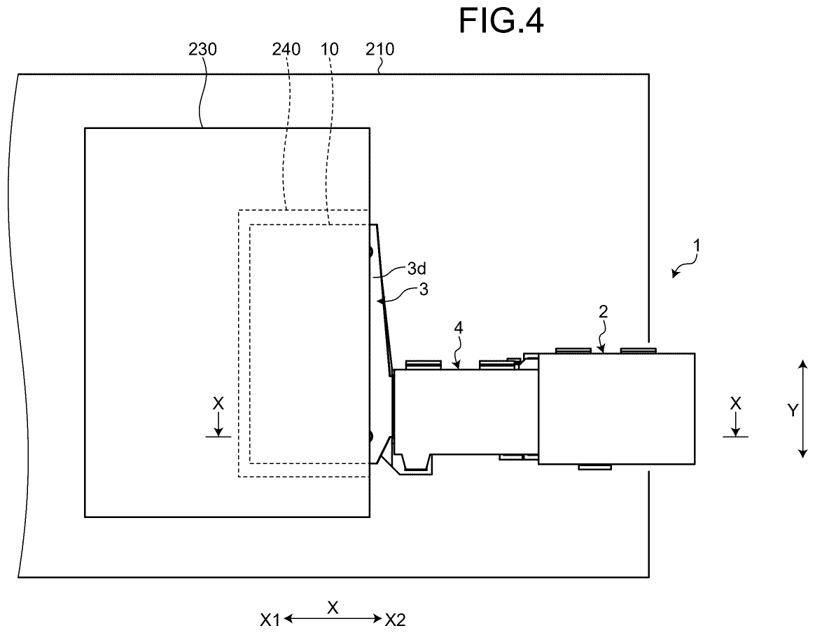

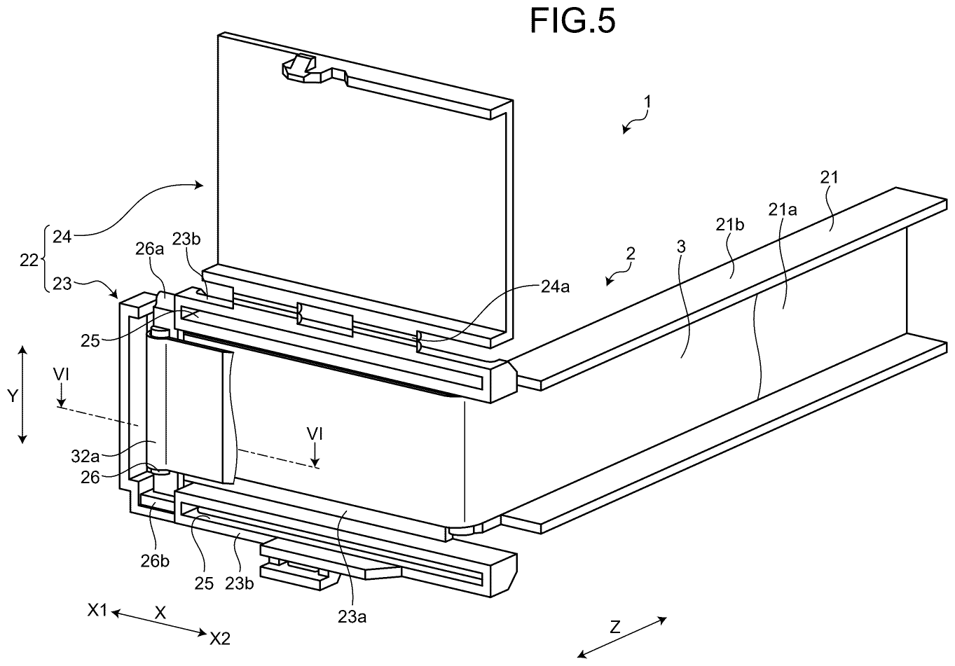

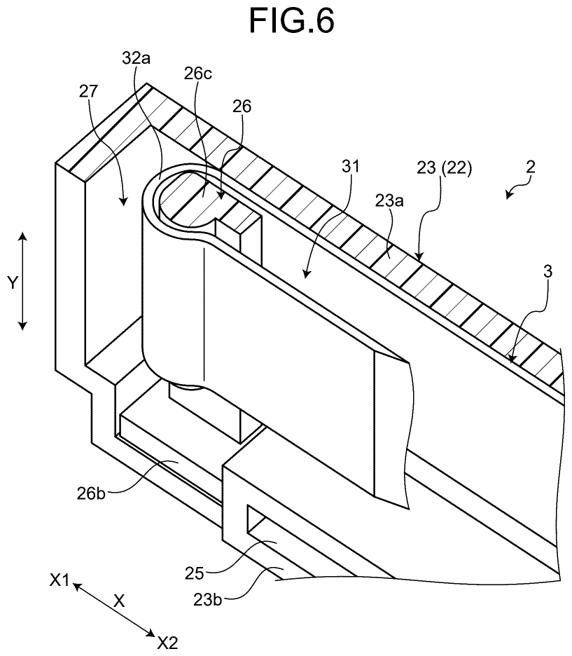

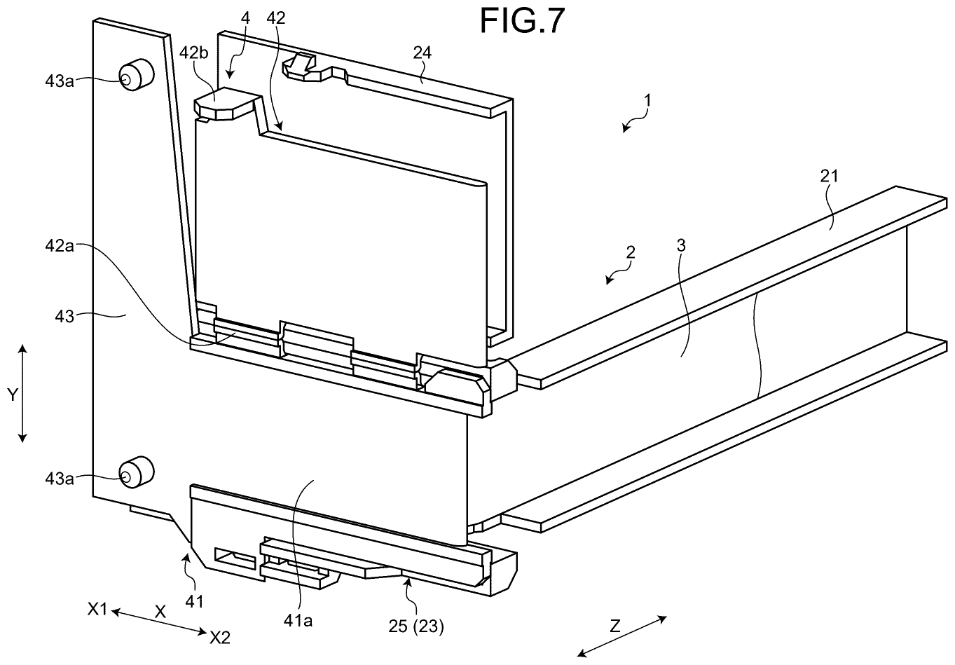

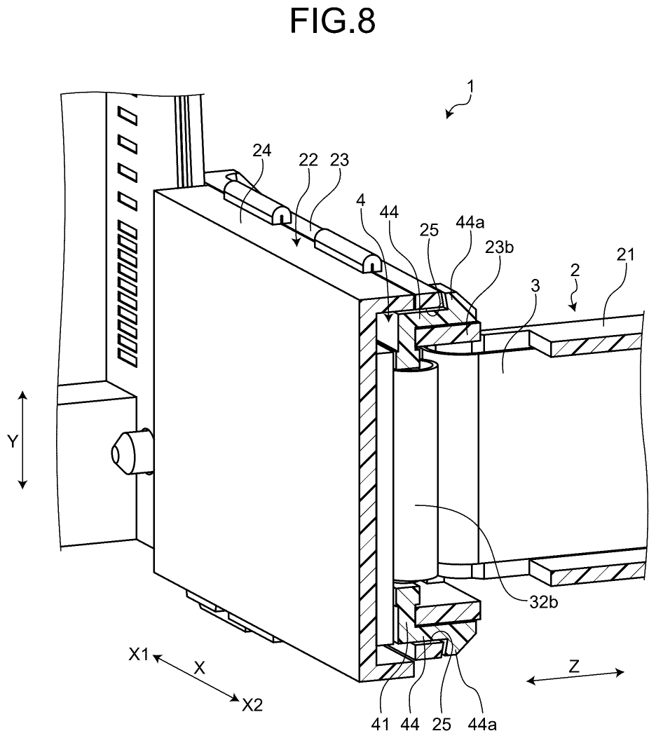

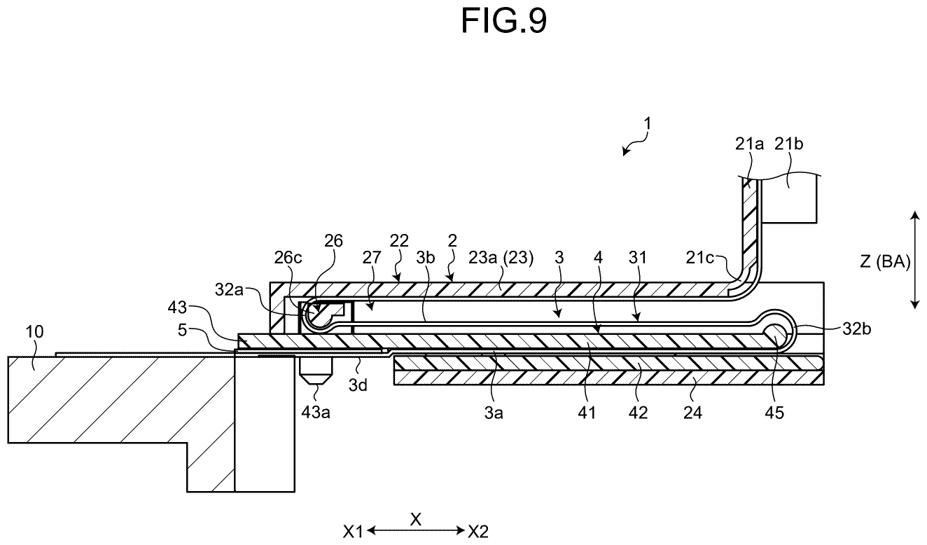

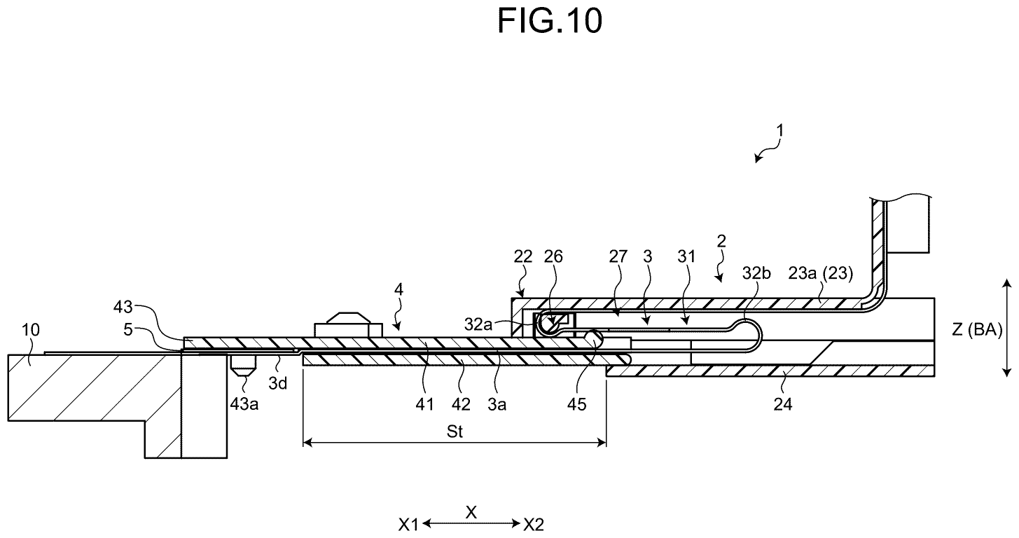

An embodiment will be described with reference to FIGS. 1 to 10. The present embodiment relates to a protector and a busbar module. FIG. 1 is a plan view of a busbar module according to an embodiment, FIG. 2 is a perspective view of a protector according to the embodiment, FIGS. 3 and 4 are plan views of the protector according to the embodiment, FIG. 5 is a perspective view of a case unit and a flexible printed wiring board according to the embodiment, FIG. 6 is a cross-sectional perspective view of the case unit and the flexible printed wiring board according to the embodiment, FIG. 7 is a perspective view of the protector according to the embodiment, FIG. 8 is a cross-sectional perspective view of the protector according to the embodiment, and FIGS. 9 and 10 are cross-sectional views of the protector according to the embodiment.

FIG. 6 illustrates a cross section taken along line VI-VI in FIG. 5. FIG. 8 illustrates a cross section taken along line VIII-VIII in FIG. 2. FIG. 9 illustrates a cross section taken along line IX-IX in FIG. 3. FIG. 10 illustrates a cross section taken along line X-X in FIG. 4.

A protector 1 of the present embodiment is a protective member for a flexible printed wiring board. The protector 1 configures, for example, a part of a busbar module 100. The busbar module 100 is assembled to a battery module 210 of a battery pack 200. The battery module 210 includes a plurality of battery cells 220. The plurality of battery cells 220 are arranged side by side along an array direction BA.

The busbar module 100 includes a plurality of busbars 110, a case 120, a flexible printed wiring board 3, a connector 10, and a protector 1. The busbar 110 can be connected to an electrode of the battery cell 220. The busbar 110 connects, for example, electrodes of two adjacent battery cells 220.

The case 120 accommodates the plurality of busbars 110 and the flexible printed wiring board 3. The case 120 is molded using, for example, synthetic resin having insulating property. The case 120 includes a holding portion that holds the busbar 110. The plurality of busbars 110 are held side by side in the array direction BA by the case 120. The case 120 is fixed to the battery module 210 while holding the plurality of busbars 110 and the flexible printed wiring board 3.

The flexible printed wiring board 3 includes a base film, a conductive layer, and a cover lay. The conductive layer is sandwiched and protected by the base film and the cover lay. The conductive layer is, for example, a conductive metal foil, and has a circuit pattern including a plurality of detection wires. The detection wire is connected to the corresponding busbar 110 or thermistor. The detection wire is connected to a monitoring unit 230 of the battery pack 200 via the connector 10.

The protector 1 is disposed, for example, at an end portion in the array direction BA of the case 120. The flexible printed wiring board 3 is routed from the case 120 to the connector 10 via the protector 1.

As illustrated in FIG. 2, the protector 1 includes a case unit 2 and a slide body 4. The case unit 2 is molded using, for example, synthetic resin having insulating property. The case unit 2 is connected to an end portion in the array direction BA of the case 120. The case unit 2 may be configured as a part of the case 120, may be engaged with an end portion of the case 120, or may be fixed to the battery module 210 or the like so as to be adjacent to the end portion of the case 120.

As described with reference to FIGS. 3 and 4, the protector 1 of the present embodiment can move the connector 10 in the sliding direction X by sliding the slide body 4 with respect to the case unit 2. The protector 1 is configured to be able to move the connector 10 to a position where the connector 10 can be fitted to the monitoring unit 230.

In the present specification, a side on which the connector 10 approaches a mating connector 240 in the sliding direction X is referred to as a “first side X1”. The mating connector 240 is a connector included in the monitoring unit 230 of the battery pack 200. The monitoring unit 230 is attached to an end portion of the battery module 210 in the array direction BA. The monitoring unit 230 is disposed in a space portion between the housing of the battery pack 200 and the end face of the battery module 210.

In the sliding direction X, a side opposite to the first side X1 is referred to as a “second side X2”. The connector 10 can be detached from the mating connector 240 by moving to the second side X2.

The connector 10 illustrated in FIG. 3 is located at an end portion on the second side X2 in the sliding direction X. That is, the connector 10 of FIG. 3 is at a position farthest from the mating connector 240 of the monitoring unit 230 in the movable range in the sliding direction X. At this time, the slide body 4 is accommodated inside the case unit 2. The slide body 4 and the connector 10 can slide to the first side X1 from the position illustrated in FIG. 3 toward the monitoring unit 230.

FIG. 4 illustrates a state in which the fitted connector 10 is fitted to the mating connector 240. The slide body 4 projects out to the first side X1 with respect to the case unit 2. The slide body 4 holds the flexible printed wiring board 3 and is fixed to the flexible printed wiring board 3. The connector 10 is connected to the end portion 3d of the flexible printed wiring board 3. Therefore, the slide body 4 can move in the sliding direction X integrally with the connector 10.

The protector 1 of the present embodiment can fit the connector 10 to the mating connector 240 in a state where both the protector 1 and the monitoring unit 230 are fixed to the battery module 210. In addition, the protector 1 of the present embodiment can remove the connector 10 from the mating connector 240 in a state where both the protector 1 and the monitoring unit 230 are fixed to the battery module 210. Therefore, the protector 1 of the present embodiment can improve the workability of the work of attaching and detaching the connector 10 to and from the monitoring unit 230.

As illustrated in FIGS. 2 and 5, the case unit 2 includes a passage portion 21, an accommodation chamber 22, and a guide portion 25. The passage portion 21, the accommodation chamber 22, and the guide portion 25 are, for example, integrally molded. The passage portion 21 is a portion that is disposed between the accommodation chamber 22 and the case 120 and guides the flexible printed wiring board 3 to the accommodation chamber 22. The passage portion 21 is disposed adjacent to an end portion of case 120. The passage portion 21 has a bottom wall 21a and a pair of side walls 21b. The passage portion 21 extends in the array direction BA.

As illustrated in FIG. 9 and the like, the accommodation chamber 22 accommodates an extra length portion 31 of the flexible printed wiring board 3. The extra length portion of the flexible printed wiring board 3 is accommodated in the accommodation chamber 22 in a state of being folded back so as to form a substantially S-shape. As illustrated in FIG. 5, the accommodation chamber 22 includes a main body 23 and a cover 24. The main body 23 has a bottom wall 23a and a pair of side walls 23b. The bottom wall 23a and the pair of side walls 23b form an accommodation space 27 illustrated in FIG. 6. The accommodation space 27 accommodates the extra length portion 31 of the flexible printed wiring board 3. The cover 24 is connected to the side surface of the main body 23 via a hinge portion 24a.

In the description of the protector 1, the accommodation chamber 22 has a width direction Y and a depth direction Z of the accommodation space 27. The depth direction Z is a direction orthogonal to the bottom wall 23a, and is, for example, the same direction as the array direction BA. The width direction Y is a direction in which the pair of side walls 23b face each other, and is a width direction of the flexible printed wiring board 3. The width direction Y and the depth direction Z are orthogonal to each other.

As illustrated in FIG. 5, the guide portion 25 is provided on the side wall 23b and extends in the sliding direction X. The sliding direction X is orthogonal to the depth direction Z. That is, the sliding direction X is orthogonal to the array direction BA of the battery cells 220.

In the main body 23, a supporting portion 26 that forms a first fold-back portion 32a on the flexible printed wiring board 3 is disposed. As illustrated in FIG. 6, the supporting portion 26 includes a columnar or beam-shaped arm 26c. The flexible printed wiring board 3 is wound around the arm 26c of the supporting portion 26. The supporting portion 26 includes a hinge portion 26a and an engagement portion 26b. The hinge portion 26a is arranged at an end portion on one side of the arm 26c, and the engagement portion 26b is arranged at an end portion on the other side of the arm 26c.

The arm 26c of the supporting portion 26 is connected to the side surface of the main body 23 via the hinge portion 26a, and is turnable with respect to the main body 23. The supporting portion 26 is engaged with the main body 23 by the engagement portion 26b. In a state where the engagement portion 26b is engaged with the main body 23, the arm 26c faces the bottom wall 23a of the main body 23. As illustrated in FIG. 6, a gap into which the flexible printed wiring board 3 can be inserted is provided between the arm 26c and the main body 23. That is, the supporting portion 26 constitutes a bridge that crosses the flexible printed wiring board 3 placed on the bottom wall 23a.

As illustrated in FIG. 6, the first fold-back portion 32a is formed by the supporting portion 26, whereby the extra length portion 31 is generated in the flexible printed wiring board 3. The first fold-back portion 32a has a fold-back shape convex toward the first side X1. The accommodation space 27 of the accommodation chamber 22 has a depth capable of accommodating the extra length portion 31.

The slide body 4 is molded using, for example, synthetic resin having insulating property. The slide body 4 slides with respect to the case unit 2 while being guided by the case unit 2. The slide body 4 is configured to hold the end portion 3d of the flexible printed wiring board 3 and slide together with the end portion 3d. The slide body 4 is movable to the first side X1 and the second side X2 within a movable range along the sliding direction X.

As illustrated in FIG. 7, the slide body 4 includes a main body 41 and a cover 42. The main body 41 and the cover 42 are, for example, integrally molded. The main body 41 has a groove 41a capable of accommodating the flexible printed wiring board 3. The groove 41a extends in the sliding direction X. The cover 42 includes a hinge portion 42a and an engagement portion 42b. The hinge portion 42a is disposed at one end of the cover 42 in the width direction, and the engagement portion 42b is disposed at the other end of the cover 42 in the width direction. The hinge portion 42a is connected to a side surface of the main body 41. The cover 42 covers the groove 41a of the main body 41, and protects the flexible printed wiring board 3.

The main body 41 and the cover 42 function as a holding portion that holds the flexible printed wiring board 3. The cover 42 is configured, for example, to hold the flexible printed wiring board 3 sandwiched between the main body 41 and the cover 42.

A wide-width portion 43 having a shape corresponding to the end portion 3d of the flexible printed wiring board 3 is formed at an end portion on the first side X1 of the main body 41. The wide-width portion 43 is provided with two protrusions 43a. The protrusion 43a is inserted into the through hole of the flexible printed wiring board 3 to hold the end portion 3d of the flexible printed wiring board 3.

As illustrated in FIG. 8, the slide body 4 has two leg portions 44. The leg portions 44 are disposed at both end portions of the main body 41 in the width direction Y. The leg portion 44 projects out from the main body 41 in the depth direction Z. A claw 44a projects out in the width direction Y is provided at the distal end of the leg portion 44. The leg portion 44 is inserted into the guide portion 25 of the case unit 2. The side wall 23b of the case unit 2 suppresses the leg portion 44 from coming out by locking the claw 44a.

The leg portion 44 is disposed at an end portion of the main body 41 on the second side X2. That is, the end portion of the slide body 4 on the second side X2 is coupled to the case unit 2. On the other hand, an end portion of the slide body 4 on the first side X1 is not coupled to the case unit 2 and is movable relative to the case unit 2. Therefore, the end portion of the slide body 4 on the first side X1 can be separated from the case unit 2. In other words, the slide body 4 is swingable with respect to the case unit 2. Since the slide body 4 is swingable in the depth direction Z, the posture of the connector 10 flexibly changes when the connector 10 is inserted into or removed from the mating connector 240.

As illustrated in FIG. 9, the slide body 4 holds the flexible printed wiring board 3 so as to form a second fold-back portion 32b on the flexible printed wiring board 3. The slide body 4 is configured to hold a portion between the connector 10 and the extra length portion 31 in the flexible printed wiring board 3. The slide body 4 of the present embodiment holds the end portion 3d of the flexible printed wiring board 3 and holds the portion 3a adjacent to the end portion 3d. The adjacent portion 3a is a portion on the side opposite to the side of the connector 10 with respect to the end portion 3d. In other words, the adjacent portion 3a is a portion located on the second side X2 with respect to the end portion 3d. The slide body 4 sandwiches the adjacent portion 3a by the main body 41 and the cover 42.

The second fold-back portion 32b is formed so as to cover the main body 41 from both sides in the depth direction Z. The second fold-back portion 32b has a fold-back shape convex toward the second side X2. In the flexible printed wiring board 3, a portion on the end portion 3d side than the second fold-back portion 32b is the adjacent portion 3a. In the flexible printed wiring board 3, a portion on the side opposite to the end portion 3d than the second fold-back portion 32b is connected to the first fold-back portion 32a. A portion 3b between the first fold-back portion 32a and the second fold-back portion 32b faces the bottom wall 23a of the case unit 2 and is accommodated in the accommodation space 27. The accommodation space 27 is formed between the bottom wall 23a of the case unit 2 and the main body 41 of the slide body 4.

As described above, the slide body 4 forms the second fold-back portion 32b on the flexible printed wiring board 3 to fold back the flexible printed wiring board 3 to a substantially U-shape. The flexible printed wiring board 3 is held by the protector 1 so as to form a substantially S-shape having two fold-back portions 32a and 32b.

The main body 41 of the slide body 4 has a protective portion 45. The protective portion 45 is provided at an end portion of the main body 41 on the second side X2. The protective portion 45 protects the flexible printed wiring board 3 so that the bend R at the second fold-back portion 32b does not become excessively small. The protective portion 45 has a substantially circular column shape. The protective portion 45 is raised toward one side in the depth direction Z. The direction in which the protective portion 45 is raised is a side toward the bottom wall 23a of the case unit 2. Therefore, the second fold-back portion 32b is curved so as to bulge toward the bottom wall 23a. As a result, an increase in the build of the slide body 4 in the depth direction Z is suppressed.

The supporting portion 26 of the case unit 2 is formed so that the bend R at the first fold-back portion 32a does not become excessively small. That is, the arm 26c of the supporting portion 26 is raised toward the main body 41 of the slide body 4 along depth direction Z.

In the case unit 2, a thin portion 21c is provided between the bottom wall 23a and the bottom wall 21a. The thin portion 21c is disposed at a corner portion where the two bottom walls 21a and 23a intersect, and is curved in an arc shape. The thin portion 21c is thinner than the two bottom walls 21a and 23a. Therefore, the thin portion 21c allows the bottom wall 21a to swing with respect to the bottom wall 23a.

In the protector 1 of the present embodiment, the accommodation chamber 22 can be swung in the depth direction Z with the thin portion 21c as a rotation center. Furthermore, as described above, the slide body 4 can be swung with respect to the accommodation chamber 22. Therefore, the protector 1 of the present embodiment enables both the position adjustment of the connector 10 in the depth direction Z and the angle adjustment of the connector 10 with respect to the sliding direction X.

The end portion 3d of the flexible printed wiring board 3 projects out from the slide body 4 and is connected to the connector 10. The slide body 4 holds the end portion 3d of the flexible printed wiring board 3 by the protrusion 43a. The illustrated protrusion 43a has a circular column shape. A reinforcement plate 5 configured to reinforce the flexible printed wiring board 3 is attached to the end portion 3d. The end portion 3d and the reinforcement plate 5 are provided with a through hole corresponding to the protrusion 43a. The protrusion 43a is inserted into the through holes of the end portion 3d and the reinforcement plate 5 to hold the end portion 3d and the reinforcement plate 5.

The slide body 4 of FIG. 9 is located at an end portion on the second side X2 in the slidable range. At this time, the protective portion 45 of the slide body 4 is located inward of the second fold-back portion 32b and supports the fold-back portion 32b.

When the slide body 4 and the connector 10 are moved to the first side X1 from this state, the extra length portion 31 of the flexible printed wiring board 3 is extended from the accommodation chamber 22. The extra length portion 31 extends from a space portion between the main body 41 of the slide body 4 and the bottom wall 23a of the case unit 2 to the external space. More specifically, when the slide body 4 is moved to the first side X1, the position where the second fold-back portion 32b is formed approaches the first fold-back portion 32a. As a result, the portion 3b between the first fold-back portion 32a and the second fold-back portion 32b is pulled out to the external space.

The slide body 4 of FIG. 10 is located at an end portion on the first side X1 in the slidable range. At this time, the protective portion 45 of the slide body 4 is separated from the second fold-back portion 32b. Most of the slide body 4 projects out from the accommodation chamber 22 to the first side X1. When the slide body 4 projects out to the end portion on the first side X1 in the movable range, the flexible printed wiring board 3 has two fold-back portions 32a and 32b. That is, the flexible printed wiring board 3 maintains a substantially S-shaped curved shape even when the slide body 4 is at any position in the movable range. As a result, the shape of the flexible printed wiring board 3 is less likely to be disturbed.

In the protector 1 of the present embodiment, the movable range St of the slide body 4 is set so that the connector 10 can be inserted into and removed from the mating connector 240. That is, the connector 10 can be detached from the mating connector 240 by moving the slide body 4 to the second side X2. In addition, the connector 10 can be completely fitted to the mating connector 240 by moving the slide body 4 to the first side X1.

As described above, the protector 1 of the present embodiment is configured such that the connector 10 can be inserted into and removed from the mating connector 240 in a state where both the mating connector 240 and the case unit 2 are fixed. Therefore, the protector 1 of the present embodiment can improve workability of attaching and detaching the connector 10 to and from the mating connector 240.

As described above, the protector 1 of the present embodiment includes the case unit 2 and the slide body 4. The case unit 2 includes an accommodation chamber 22 and a guide portion 25. The accommodation chamber 22 accommodates the extra length portion 31 of the flexible printed wiring board 3 to which the connector 10 is connected. The guide portion 25 extends along the sliding direction X. The slide body 4 includes a holding portion. The holding portion holds a portion between the connector 10 and the extra length portion 31 in the flexible printed wiring board 3. The slide body 4 of the present embodiment has, as the holding portion, a sandwiching structure by the main body 41 and the cover 42 and a protrusion 43a. The main body 41 and the cover 42 hold the portion 3a adjacent to the end portion 3d of the flexible printed wiring board 3. The protrusion 43a holds the end portion 3d of the flexible printed wiring board 3.

The case unit 2 and the slide body 4 are configured to enable extending operation and accommodating operation. The extending operation is an operation of extending the extra length portion 31 from the accommodation chamber 22. The case unit 2 and the slide body 4 are configured to extend the extra length portion 31 from the accommodation chamber 22 by the slide body 4 moving to the first side X1 in the sliding direction X.

The accommodating operation is an operation of accommodating the extra length portion 31 in the accommodation chamber 22. The case unit 2 and the slide body 4 accommodate the extra length portion 31 extending from the accommodation chamber 22 in the accommodation chamber 22 by the slide body 4 moving to the second side X2 in the sliding direction X. The protector 1 of the present embodiment can improve the workability of the work of attaching and detaching the connector 10 to and from the mating connector 240 by moving the connector 10 in the sliding direction X.

The case unit 2 and the slide body 4 of the present embodiment are configured such that the plurality of fold-back portions 32a and 32b are formed in the extra length portion 31 and the extra length portions 31 are stacked in the accommodation chamber 22. In the illustrated protector 1, two fold-back portions 32a and 32b are formed on the flexible printed wiring board 3, and the extra length portion 31 is stacked in the accommodation space 27. In the flexible printed wiring board 3, the stacked portions may be separated from each other or may be in contact with each other. Since the extra length portions 31 are stacked and accommodated, the height reduction of the case unit 2 is achieved.

The case unit 2 of the present embodiment has a supporting portion 26. The supporting portion 26 forms the first fold-back portion 32a on the extra length portion 31 to support the first fold-back portion 32a from the inside. The first fold-back portion 32a has a fold-back shape convex toward the first side X1. The supporting portion 26 supports the first fold-back portion 32a and can stabilize the shape of the extra length portion 31.

The slide body 4 of the present embodiment holds the flexible printed wiring board 3 by the holding portion so as to form the second fold-back portion 32b in the extra length portion 31. For example, the sandwiching structure by the main body 41 and the cover 42 sandwiches the adjacent portion 3a so as to form the second fold-back portion 32b. The holding portion of the slide body 4 can stabilize the shape of the extra length portion 31.

The busbar module 100 of the present embodiment includes a protector 1, a flexible printed wiring board 3, a connector 10 connected to the flexible printed wiring board 3, and a plurality of busbars 110. The plurality of busbars 110 are connected to the flexible printed wiring board 3 and can be connected to the electrodes of the battery cell 220. The busbar module 100 of the present embodiment can improve workability of work of attaching and detaching the connector 10 to and from the mating connector 240.

A target to which the protector 1 of the present embodiment is applied is not limited to the busbar module 100. The mating connector 240 is not limited to the connector included in the monitoring unit 230.

The protector 1 may be applied to, for example, the flexible printed wiring board 3 routed along the vehicle body of the vehicle. The flexible printed wiring board 3 in this case may connect an electronic control unit (ECU) and a device controlled by the ECU. The mating connector 240 may be a connector included in the ECU or a connector included in the device to be controlled. In the protector 1 of this embodiment, in a state where both the mating connector 240 and the protector 1 are fixed, the connector 10 can be fitted to the mating connector 240, or the connector 10 can be detached from the mating connector 240.

The slide body 4 may have a holding portion that holds the connector 10. In this case, when a force in the sliding direction X is applied to the slide body 4 and the connector 10, the force is less likely to act on the flexible printed wiring board 3.

The number of fold-back portions formed in the extra length portion 31 is not limited to the two illustrated examples. In the protector 1, three or more fold-back portions may be formed in the extra length portion 31. The shape of the extra length portion 31 accommodated in the accommodation chamber 22 is not limited to the S-shape. For example, the extra length portion 31 may be accommodated in the accommodation chamber 22 in an arbitrary shape. When the shape of the extra length portion 31 in the accommodation chamber 22 is not controlled, the case unit 2 may not have the supporting portion 26, and the slide body 4 may not have the protective portion 45.

### Modified Example of Embodiment

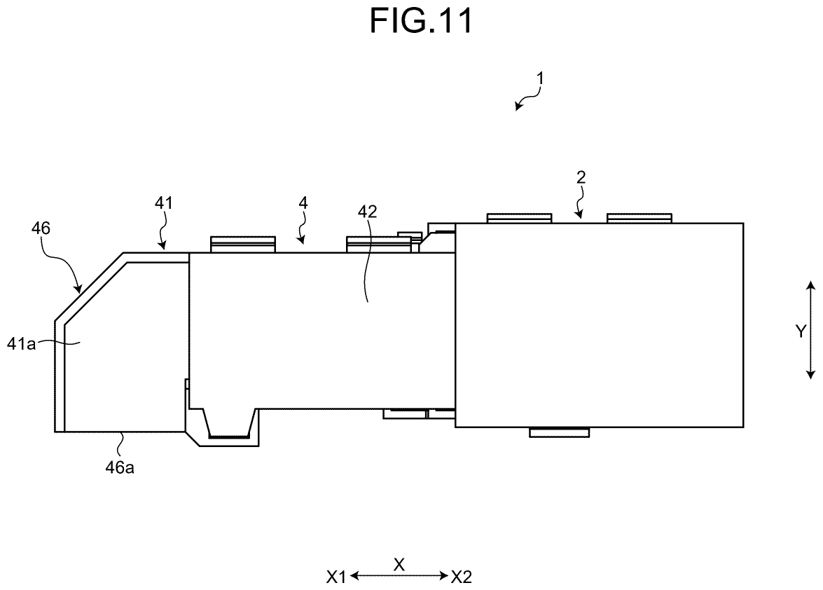

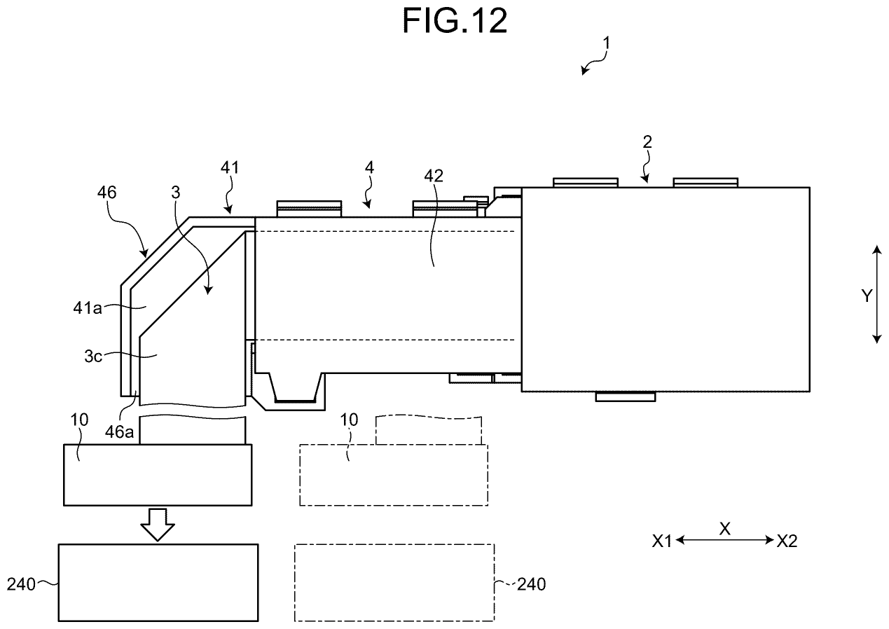

A protector 1 according to a modified example of the embodiment will be described with reference to FIGS. 11 and 12. FIGS. 11 and 12 are plan views of a protector according to a modified example of the embodiment. The protector 1 according to the modified example of the embodiment is different from the protector 1 of the above embodiment in that, for example, the flexible printed wiring board 3 extends toward the width direction Y.

As illustrated in FIG. 12, in the protector 1 according to the modified example of the embodiment, the flexible printed wiring board 3 and the connector 10 extend from the slide body 4 toward the width direction Y. As a result, even if the position of the mating connector 240 in the sliding direction X is different, the connector 10 can be positioned at an appropriate position with respect to the mating connector 240.

As illustrated in FIG. 11, the main body 41 of the slide body 4 has a projection 46. The projection 46 projects out to the first side X1 with respect to the cover 42. The projection 46 has a groove 41a capable of accommodating the flexible printed wiring board 3. The projection 46 is provided with a pull-out port 46a. The pull-out port 46a is opened toward the width direction Y.

As illustrated in FIG. 12, a bent portion 3c is formed on the flexible printed wiring board 3. The bent portion 3c is bent so as to change the extending direction of the flexible printed wiring board 3 by 90°. The distal end side of the bent portion 3c in the flexible printed wiring board 3 projects out from the pull-out port 46a along the width direction Y. The flexible printed wiring board 3 is provided with an extra length corresponding to a stroke for insertion and removal with respect to the mating connector 240. That is, in the flexible printed wiring board 3, the portion projecting out from the pull-out port 46a has an extra length that allows the connector 10 to be fitted to the mating connector 240.

The slide body 4 can position the connector 10 at an arbitrary position in the movable range by moving along the sliding direction X. Therefore, the protector 1 according to the modified example of the embodiment can improve the workability of the work of attaching and detaching the connector 10 to and from the mating connector 240.

In the protector according to the present embodiment, a case unit and a slide body cause an extra length portion of a flexible printed wiring board to be extended from an accommodation chamber as the slide body moves to a first side in a sliding direction, and accommodate the extra length portion extending from the accommodation chamber in the accommodation chamber as the slide body moves to a second side in the sliding direction. According to the protector of the present invention, an effect that the workability of the work of connecting the connector connected to the flexible printed wiring board to the mating connector can be improved is obtained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protector comprising:
a case unit including an accommodation chamber that accommodates an extra length portion of a flexible printed wiring board to which a connector is connected, and a guide portion extending along a sliding direction; and
a slide body that includes a holding portion that holds a portion between the connector and the extra length portion in the flexible printed wiring board, and moves along the sliding direction while being guided by the guide portion, wherein
the case unit and the slide body are configured to cause the extra length portion to be extended from the accommodation chamber when the slide body is moved to a first side in the sliding direction, and cause the extra length portion extending from the accommodation chamber to be accommodated in the accommodation chamber when the slide body is moved to a second side in the sliding direction.

2. The protector according to claim 1, wherein
the case unit and the slide body are configured to form a plurality of fold-back portions in the extra length portion and stack the extra length portion in the accommodation chamber.

3. The protector according to claim 2, wherein
the case unit includes a supporting portion that forms a first fold-back portion in the extra length portion and supports the first fold-back portion from inside, and
the first fold-back portion has a fold-back shape convex toward the first side.

4. The protector according to claim 2, wherein
the slide body holds the flexible printed wiring board by the holding portion so as to form a second fold-back portion in the extra length portion, and
the second fold-back portion has a fold-back shape convex toward the second side.

5. A busbar module comprising:
the protector according to claim 1;
the flexible printed wiring board;
the connector connected to the flexible printed wiring board; and
a plurality of busbars connected to the flexible printed wiring board and connectable to an electrode of a battery cell.
